(19) United States
(12) Patent Application Publication
(10) Pub. No.: US 2012/0203521 A1
(43) Pub. Date: Aug. 9, 2012

(54) METHOD, APPARTUS AND SYSTEM FOR IMPROVED GROUNDWATER MODELING

(76) Inventors: Serguei Chmakov, Waterloo (CA); Wayne Hesch, Waterloo (CA); Peter Sychev, Dubna (RU); Collin Tu, Waterloo (CA); Igor Evsikov, Waterloo (CA); Lilia Garcia, Kitchener (CA); Jose Marconi De Barros Lima, Boa Biagem (BR)

(21) Appl. No.: 13/320,763

(22) PCT Filed: May 18, 2010
(86) PCT No.: PCT/CA10/00745

§ 371 Date: Apr. 25, 2012

Related U.S. Application Data
(60) Provisional application No. 61/179,240, filed on May 18, 2009.
(60) Provisional application No. 61/179,696, filed on May 19, 2009.

(51) Int. Cl. G06G 7/48; G06F 7/60

(52) U.S. Cl. 703/2; 703/10

(57) ABSTRACT

A method of groundwater modeling is disclosed comprising: collecting, inputting, organizing and managing raw data concerning an aquifer in a data workspace; developing a conceptual groundwater model, by creating a structural sub-model, a property sub-model and a boundary condition sub-model; using the conceptual groundwater model to define a set of one or more simulation models; converting the one or more simulation models into one or more numerical groundwater models having one or more grid types; and miming a simulation using one or more of the numerical models and analyzing the results.

### CROSS-REFERENCE TO RELATED APPLICATIONS

This application claims benefit of U.S. Provisional Patent Application Nos. 61/179,240 filed on May 18, 2009 and 61/179,696 filed on May 19, 2009, with attorney docket number 105.0009 and entitled “Method, Apparatus and System for Improved Groundwater Modeling,” both of which are hereby incorporated herein by reference in their entirety.

### BACKGROUND

The subject matter disclosed in this specification relates to methods and systems for use in groundwater modeling, and, in particular, relates to methods, apparatus, and systems for more effectively and efficiently modeling groundwater for better aquifer management.

The groundwater modeler has to deal with different types of uncertainties, in particular with parameter uncertainties (Hill, 2007, Doherty 2007) and conceptualization uncertainties (Poeter, 2006). In order to handle conceptualization uncertainty, the modeler needs to create a reasonable set of different alternative conceptual models. This in turn, produces a demand for the software giving the modeler a tool for developing such conceptualizations. Currently the cost of developing such alternative models is usually so prohibitive that the majority of the projects can only afford to explore the effects of parameter uncertainties.

The groundwater model development is inherently very complex and comprises of a number of tasks that requires the hydrogeologist to use a vast variety of tools. One of the main challenges for the graphical user interfaces and visualization software is to organize the tools and provide an intuitive workflow for the model development from raw data to the numerical model. Sometimes, even though the appropriate tools are available, the modeler is getting lost trying to navigate to the right tool at the right time.

Another challenge is that raw data is usually handled outside of the model building workflow. Workflows for creating groundwater-meaningful objects from the raw data are usually left beyond the graphical user interfaces for simulation software, which makes it difficult to trace the final model to the original data.

### SUMMARY

One aspect of the present invention involves a method of groundwater modeling including collecting, inputting, organizing and managing raw data concerning an aquifer in a data workspace; developing a conceptual groundwater model, by creating a structural sub-model, a property sub-model and a boundary condition sub-model; using the conceptual groundwater model in a simulation; converting conceptual groundwater model into a numerical groundwater model having one or more grid types; and running simulation and analyzing the results. Simulation results can be used to identify steps to improve aquifer management.

A further aspect of the present invention involves an apparatus for modeling a groundwater aquifer comprising: a data workspace having data in the form of one or more objects, each object having a geometry and at least one attribute attached to the geometry; a coordinate system for use in editing the objects; a conceptual model workspace having one or more conceptual model objects in one or more folders, the conceptual objects having been created from the data objects though one or more operations; a conceptual model created from conceptual objects, having a structural sub-model, a property sub-model and a boundary condition sub-model; an editor for editing objects in the data workspace to create the conceptual model objects for the conceptual data workspace; a multi-dimensional viewer to view objects in the data workspace and to view conceptual model objects in the conceptual model workspace; and a simulation model having one or more grid types, the simulation model created from the conceptual model by adding a simulation domain and one or more grid types.

A further aspect of the present invention involves a system for building a aquifer model comprising: one or more sources of raw data concerning the aquifer; a conceptual model builder having a data workspace for importing the raw data from the one or more sources of raw data, the raw data taking the form of one or more objects, each object having a geometry and at least one attribute attached to the geometry; a coordinate system for use in editing the objects; a conceptual model workspace having one or more conceptual model objects in one or more folders, the conceptual objects having been created from the data objects through one or more operations; a conceptual model created from conceptual objects, having a structural sub-model, a property sub-model and a boundary condition sub-model; an editor for editing objects in the data workspace to create the conceptual model objects for the conceptual data workspace; a multi-dimensional viewer to view objects in the data workspace and to view conceptual model objects in the conceptual model workspace; a simulation model having one or more grid types, the simulation model created from the conceptual model by adding a simulation domain and one or more grid types; one or more numerical models translated from the simulation model; and a simulator for running the numerical models.

A further aspect of the present invention involves a program storage device readable by a machine tangibly embodying a program of instructions executable by the machine to perform method steps for groundwater modeling, said method steps comprising: inputting, organizing and managing collected raw data concerning an aquifer in a data workspace as objects; creating conceptual model objects in a conceptual model workspace from the objects though one or more operations; developing a conceptual groundwater model from the conceptual model objects, by creating a structural sub-model, a property sub-model and a boundary condition sub-model; using the conceptual groundwater model to define a set of one or more simulation models; converting the one or more simulation models into one or more numerical groundwater models having one or more grid types; and running a simulation and analyzing the results.

A further aspect of the present invention involves a system for modeling groundwater comprising a processor, a data storage system, at least one input device, and at least one output device, a computer-readable media for storing data, the system comprising: a data workspace for imported raw data collected from one or more sources of raw data, the raw data taking the form of one or more objects, each object having a geometry and at least one attribute attached to the geometry; a coordinate system for use in editing the objects; a conceptual model workspace having one or more conceptual model objects in one or more folders, the conceptual objects having been created from the data objects though one or more operations; a conceptual model created from conceptual objects, having a structural sub-model, a property sub-model and a boundary condition sub-model; an editor for editing objects in the data workspace to create the conceptual model objects for the conceptual data workspace; a multi-dimensional viewer to view objects in the data workspace and to view conceptual model objects in the conceptual model workspace; and a simulation model having one or more grid types, the simulation model created from the conceptual model by adding a simulation domain and one or more grid types; one or more numerical models translated from the simulation model; and a simulator for running the numerical models.

Other objects, features and advantages of the present invention will become apparent to those of skill in art by reference to the figures, the description that follows and the claims.

### BRIEF DESCRIPTION OF THE DRAWINGS

FIG. 1 is a flowchart of an embodiment of the present invention.

FIG. 2 is block diagram of an embodiment of the present invention.

FIG. 3 is a depiction of feature zonation as in an embodiment of the present invention.

FIG. 4 depicts horizon types as in an embodiment of the present invention.

FIG. 5 depicts multiple numerical models (e.g., MODFLOW, FEFLOW), having different grid types, translated from the same conceptual model as in an embodiment of the present invention.

FIG. 6 is a simplified depiction of an underground aquifer intersected by a monitoring well having a sensor system for collecting raw data as in an embodiment of the present invention.

FIG. 7 depicts a computer system and a hard disk, in accordance with an embodiment of the present invention.

### DETAILED DESCRIPTION

In the following detailed description of a preferred embodiment and other embodiments of the invention, reference is made to the accompanying drawings. It is to be understood that those of skill in the art will readily see other embodiments and changes may be made without departing from the scope of the invention.

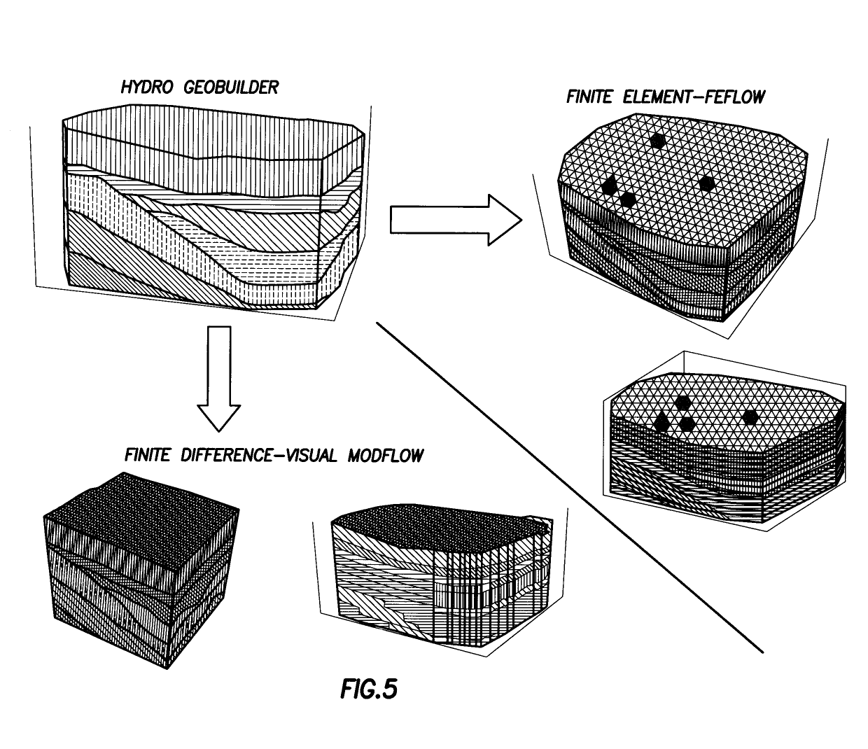

This specification discloses a software application, called a ‘Hydro GeoBuilder (HGB)’ which functions as a Conceptual Model Builder (CMB), that provides visual 3D tools for developing a ‘conceptual model’ of a groundwater study. Hereinafter, the ‘Hydro GeoBuilder (HGB)’ software application will be referred to as either the ‘HGB software application’ or as the ‘HGB’. The conceptual model is grid and simulator independent. The conceptual model can be translated to different numerical models, such as USGS MODFLOW, finite element (for instance, FEFLOW), and finite volume groundwater models (for example see FIG. 5). During translation, the conceptual model is converted to a numerical model input file format, which can be opened by a numerical model preprocessor, such as SWS Visual MODFLOW or WASY FEFLOW, or executed directly by the corresponding engine, such as (but not limited to) USGS MODFLOW. The translation from conceptual model to simulation model to numerical model may be fully automated, thus reducing potential for user error, and provides a number of QA/QC (quality assurance, quality control) validations which might not be possible if done manually.

The HGB software application disclosed herein implements a concept of multiple local models developed in the context of a single regional model thus providing strong parent-daughter relation between the models.

The numerical grid is not considered to be a part of the conceptual model thus facilitating quick and easy re-generating of the numerical model files using different discretizations. This is different from other numerical model pre-processors where the numerical grid is introduced at the early stages of the model development and input parameters are assigned directly to the numerical grid mesh elements. Although being independent of the conceptual model, the numerical grid can take into account conceptual model elements.

Boundary conditions for the simulator are considered as grid-independent objects thus making provisions for utilizing various models to simulate boundary conditions behavior ranging from simple analytical to complex numerical surface water models. In order to unify their behavior and facilitate conceptual to numerical model translation, these models are exposed via OpenMI compliant interface, which prior to releasing this software, has only been used for linking numerical engines.

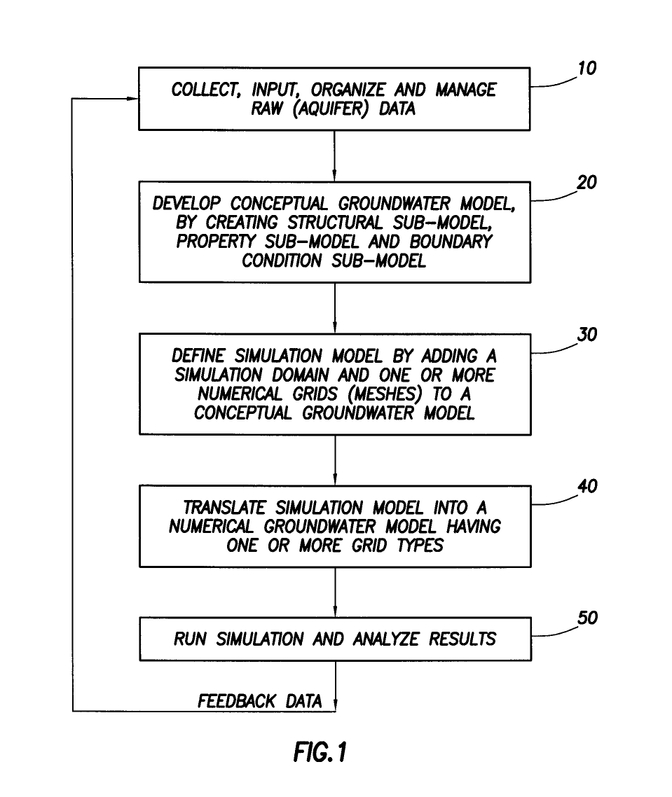

Referring to FIG. 1, the HGB software application disclosed herein focuses on arranging the building of the model into a natural workflow from Data Processing=>Conceptual Model=>Simulation Model=>Numerical Model=>Simulation=>Analysis of Results as depicted in FIG. 1. The simulation related part of workflow is taken care of by commercially available programs such as Visual MODFLOW. When the simulation is performed, the results (heads, concentrations, etc.) can be analyzed in Visual MODFLOW or brought back into the Conceptual Model Builder for further analysis.

FIG. 1 is a flowchart for an embodiment of the HGB software application disclosed in this specification. One of the first steps in developing a groundwater model is to collect the necessary data, and build a conceptual model. This is depicted as step 10 of FIG. 1. The next step is to develop a conceptual groundwater model (also called herein “conceptual model”), depicted as step 20 of FIG. 1, The conceptual model is an interpretation of the major processes occurring in the aquifer; this includes the soil properties, groundwater flow directions, the geology, wells, and influence of rivers and lakes, etc. It is a challenge to maintain, analyze, and visualize these typically multi-dimensional data, which originate from a number of sources in various file formats. Outside of the present invention, this process generally requires the use of multiple tools taking care of different aspects of the task.

Once the conceptual model is created, the modeler needs to convert it to a particular numerical model, which is another challenging task, especially when a number of scenarios need to be investigated in order to ensure model credibility.

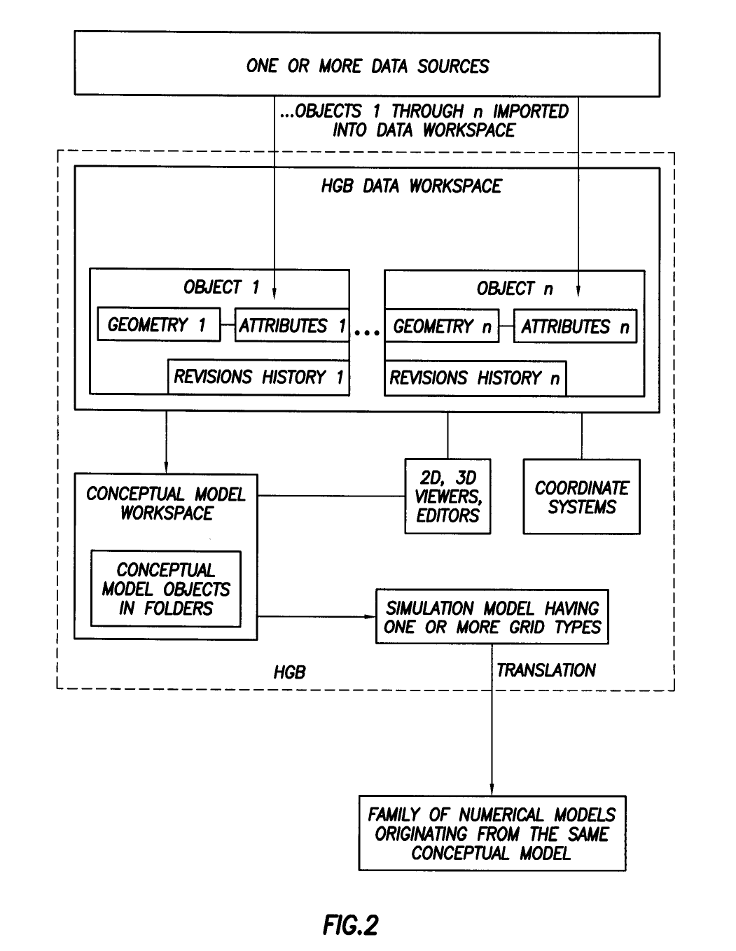

Referring to FIGS. 1 and 2, in step 10 of FIG. 1, raw data concerning the aquifer is collected, imported, organized and managed. As depicted in FIG. 2, the HGB software application (which functions as a Conceptual Model Builder or CMB) provides an ‘HGB Data Workspace’ (or ‘data workspace’) for organizing and management of the raw data. The object complexity ranges from rather simple ones such as points, polylines, polygons and surfaces to as complex as wells (vertical, deviated, or horizontal), or vertical cross-sections. The objects share a common characteristic: they are not required to carry any hydrogeological semantics. As depicted in FIG. 2, the objects at this level are considered to be just pure geometry with attached attributes having little or no semantics with respect the modeling goal. In an embodiment of the present invention, the HGB software application allows the modeler to load the raw data in the context of the modeling project into the data workspace and organize the data for future use depending on the modeling objectives. At all times the raw data stored in the objects are left intact and kept grid-independent.

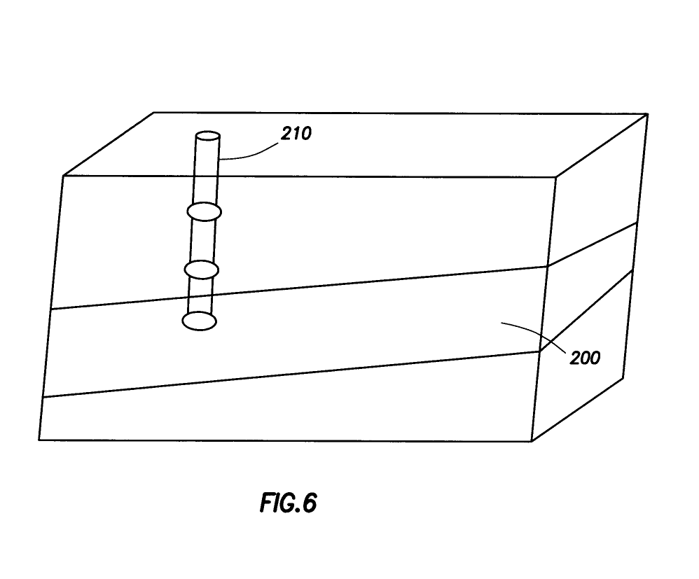

Referring to FIG. 6, this FIG. 6 is a simplified drawing of an aquifer below ground level, intersected by a monitoring well having a sensor system. Sensors systems, such as the Schlumberger Westbay System, may record pressure, temperature, provide pressure profiles or even permit fluid sampling. In FIG. 1, this is one method that may be used to collect the ‘raw (aquifer) data’ (refer to step 10 of FIG. 1).

In FIG. 2, the objects can be imported from a variety of data sources such as Digital Elevation Models (DEM), shapefiles, spreadsheets, databases, or created manually. The list of supported formats is open and can be extended as necessary. To facilitate import of geographical information, the HGB supports a number of geographic (NAD27, NAD83, WGS72, WGS84) and projected (UTM NAD27, UTM NAD83, UTM WGS84 North, UTM WGS72 North, SPCS27, SPCS83) coordinate systems and transformations between them. User-defined non-earth coordinate systems are also supported.

Although the objects may not be used directly in the numerical model, they serve as its building blocks. To facilitate this, each object exposes a set of operations to change its own state or generate other objects. Possible examples of operations includes creating surfaces from points using various interpolation methods, spatial transformation like shifting and rotating, converting points to polylines, etc. Operations may include another object as operands, for instance it is possible to drape a polygon on a surface. To facilitate traceability of the model, each object carries with it a revision history: the creation date and the author of the object, what other data were used, and what operations were applied to it. Operations are typically used in the data management workflows to “massage” raw data in order to make them as “close” to conceptual model object as possible. This would typically take place in step 10 of FIG. 1. For instance, information on geological formations often comes in form of points or cross-section objects, while conceptual model requires surfaces as the input for applying business rules based on horizon types. Point and cross-section data objects are converted to surfaces via interpolation operations to serve as input to creating horizon workflows for structural modeling.

An embodiment disclosed herein makes use of plug-in based architecture and allows adding more data objects with required functionality as necessary. Adding a new data object does not require recompiling the whole application—the new data objects are preferably deployed in the form of .Net assemblies. Each such .Net assembly is accompanied by a manifest that allows the HGB to discover and load them into the project data workspace dynamically. The set of consistent programmatic interfaces facilitates using the objects as the operands for the operations.

Another feature of the HGB is a set of ‘2D and 3D viewers and editors’, as shown in FIG. 2. Rather than limit the user to a set of fixed views of the model being developed, the HGB introduces a concept of universal viewers and editors. Any object created in the project workspace can be visualized provided it exposes a set of pre-defined programmatic interfaces. The modeler can display a number of 2D and 3D views and have different objects simultaneously visualized in those views. The editing process includes geometry editing and attributes editing. Geometry editing can be performed concurrently in a graphical or tabular view thus allowing for increased level of control on the object geometry changes. If the object being edited is simultaneously visualized in other graphical views, all the changes are reflected live in those views during the editing session. To increase usability all editing includes multi-level undo capabilities.

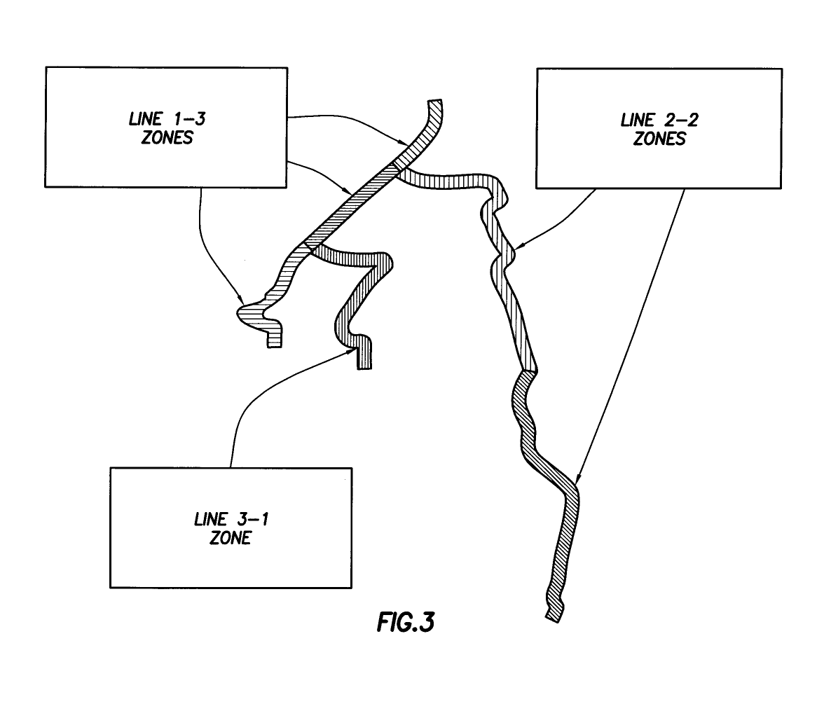

Referring to FIG. 3, attribute editing is based on a selector mechanism that allows the modeler to delineate zones in data objects where attributes of the object's geometrical elements can be specified in a uniform way. FIG. 3 shows a simple example, where lines imported from a shapefile were delineated in a number of zones and used for assigning a river boundary condition. Each zone is assigned a particular method for defining attributes. There are a number of methods that can be used to define the attributes: constant value, linear interpolation between nodes, values from a surface data object (imported from DEM), values from a set of river gauge stations, etc. Once again, the modeler can make use of data objects loaded into the data workspace—for instance assign river stage from a DEM imported during the course of data management activity. This mechanism is similar to the one used in Visual MODFLOW (Chmakov, 2003) to handle the MODFLOW Stream Routing Package (STR) (Prudic, 1989). Although the example presented in FIG. 3 is one dimensional, the zone based approach for assigning and editing the attributes does not depend on the object dimension, and is similarly used for attributes of 2D and 3D objects. This mechanism is used for defining both property and boundary condition attributes.

Referring again to FIG. 2, the Conceptual Model in the HGB software application is represented by a ‘Conceptual Model workspace’ or ‘CM workspace’ or ‘Conceptual Workspace’ that is separate from that of the ‘HGB Data Workspace’. Similar to the ‘HGB Data Workspace’, the content of the ‘Conceptual Model Workspace’ is comprised of objects. The difference between the objects in the conceptual model (“conceptual model objects” or “CM objects”) and the objects in the HGB Data Workspace is that conceptual model objects must have particular semantics and adhere to business rules specific to the conceptual model objects. The Conceptual Model (CM) workspace contains a fixed structure of folders for organizing the CM objects. In contrast to the HGB Data Workspace, there is no option to have arbitrary objects in the conceptual model—the CM structure is fixed and the modeler typically builds CM objects using data objects as building blocks. The modeler can create as many conceptual models as (s)he wants, using objects from data workspace.

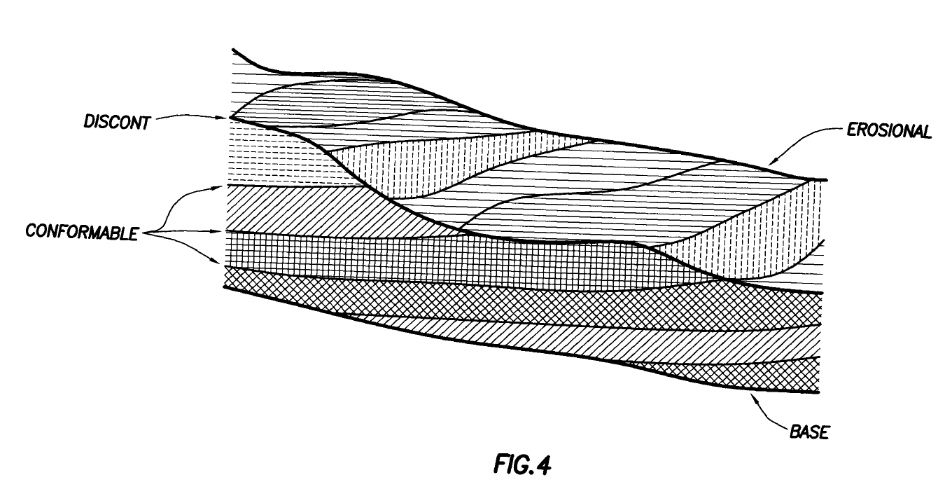

Referring to FIG. 4, in an embodiment of the HGB software application disclosed herein, each conceptual model is comprised of three sub-models: Structural Model, Property Model, and Boundary Condition Model, each one with its own (fixed) structure. Accordingly, as depicted in step 20 in FIG. 1, the CM creation workflow includes creating these models in succession. The Structural Model (SM) consists of a bounding polygon and a set of horizons; the horizons represent the geological structure of the site. Typical SM creation workflow assumes creating horizons from surfaces existing in the data workspace (surfaces can be imported or created from 2D-XY scatter points, cross-section interpretations, or well tops). In FIG. 4, at this step, the HGB enforces business rules for different types of horizons (base, erosional, conformable, and discontinuous as shown in FIG. 4) by properly modifying the original surfaces used for horizon creation. The horizons used in the present invention are preferably those used in the commercially available PETREL software, available from Schlumberger. The volumes in between the horizons constitute the structural zones used later on for property modeling.

Referring to FIG. 5, this FIG. 5 depicts multiple numerical models (e.g., MODFLOW, FEFLOW), having different grid types, translated from the same conceptual model. At the next step, the property zones are created using structural zones as the compartmental basis; the modeler has an option to further subdivide the compartment structure provided by the structural model using data objects such as polygons and surfaces in order to create more property zones. Based on these property zones the modeler assigns property attributes required by the modeling objectives. The most complex part of conceptual modeling is defining the Boundary Conditions (BC). In essence, these are independent models ranging from relatively simple ones that are incorporated in the main simulator (for example River BC in MODFLOW) to rather complex models like MIKE 11 (Havnø et al, 1995) providing very detailed model for channel flow. In both cases, however, the external models share the same geometry (river network) but require a different set of model attributes. In the first case (MODFLOW River BC), it is sufficient to specify just a few attributes; in the second case (MIKE 11) there is a complex workflow defining the model which is linked together through OpenMI interface. On the HGB side, however, specifying MIKE 11 as the BC model of choice is rather simple—the modeler should just specify a path to the .omi manifest of the respective MIKE 11 project (Graham, Chmakov et al., 2006). A simplified linking, where boundary conditions for the numeric model are taken from another model—numerical or analytical—can also be handled this way. On the conceptual level a numerical model is represented by its simulation domain. In step 30 of FIG. 1 a simulation model is defined by adding a simulation domain and one or more numerical grids (meshes) to a conceptual model. There can be more than one simulation domain for every conceptual model, thus providing a method to generate a regional-local relationship between the numerical models and facilitate scenarios with local grid refinement. Each simulation domain can have one or more numerical grids attached to it, which defines the horizontal discretization. The grid (mesh), though not linked to the conceptual model, is defined in this workspace only at the time of translating the conceptual model to the numerical model. It is important to emphasize, that in the contrast to the conventional approach, the numerical grid/mesh is not used as the definition domain for the model properties—it only serves as one of the inputs to the process of translating a conceptual model to the simulation model and then to a numerical model. In FIG. 5, if the project objectives change, a new numerical model can be easily generated (FIG. 5), or existing ones updated, from the conceptual objects. This way the modeler can explore different modeling scenarios by changing discretizations, boundary conditions or, ultimately, even switch to another main simulator (MODFLOW, FEFLOW, ECLIPSE, analytical models, etc.). Including numerical grid/mesh into conceptual model to form a simulation model allows one to establish a link between the conceptual model and the resulting numerical model(s) and simplifies the process of bringing the simulation result back into the Conceptual Model Builder.

In FIG. 1, in step 40 of FIG. 1, the simulation model is translated into a numerical groundwater model having one or more grid types. At that point, a simulation may be run (step 50 of FIG. 1) and the results analyzed. The results may be compared to aquifer performance and may lead to steps to better manage the aquifer. The results may also be fed back into the process.

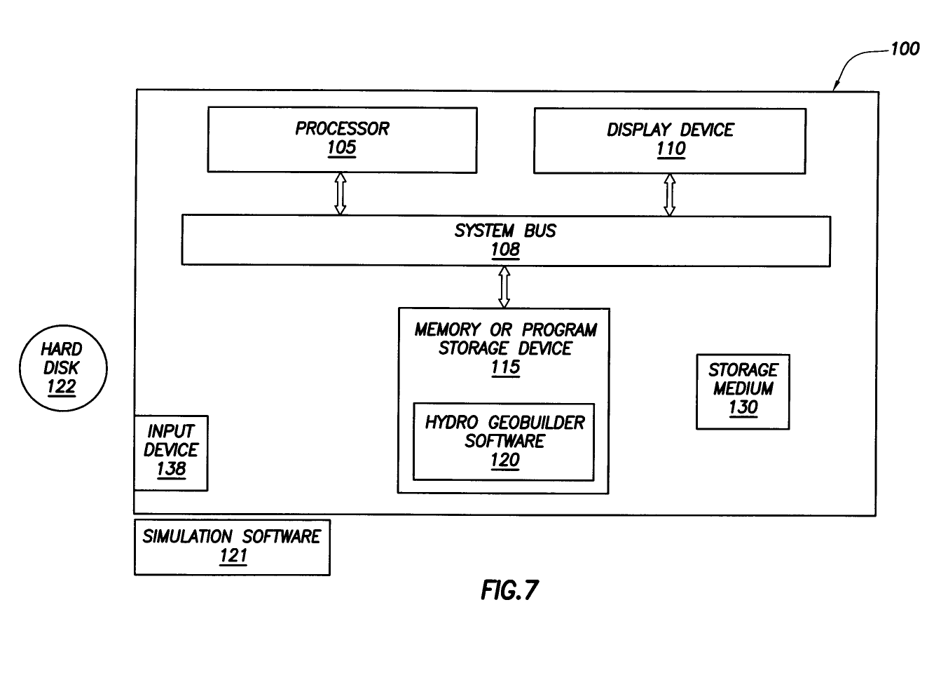

Referring to FIG. 7, a computer system 100 and a hard disk 122 according with a preferred embodiment of the present invention is illustrated. The computer system 100 includes a processor 105 connected to a system bus 108, a display device 110 connected to the system bus 108, and a memory or program storage device 115 connected to the system bus 108. The display device 110 is adapted for display of output, such as visualizations of objects or conceptual model objects as previously described. In accordance with an embodiment of the HGB software application disclosed herein, the memory or program storage device 115 is adapted to store a software in accordance with the present invention, such as the Hydro GeoBuilder (HGB) [symbol] software 120 (or HGB software 120), or other embodiments of the HGB software 120 of the present invention. The Hydro GeoBuilder (HGB) software 120 (or HGB software 120) is preferably originally stored on a hard disk 122 or other program storage device; however, in FIG. 7, the hard disk 122 was previously inserted into a reader (not depicted in FIG. 7) of the computer system 100 and the HGB software 120 was loaded from the hard disk 122 into the memory or program storage device 115 of the computer system 100 of FIG. 7. The HGB software 120 contains programming sufficient to perform the steps depicted in FIG. 1 (or other steps in accordance with other embodiments of the software application disclosed herein). Simulation software 121 which uses output of the HGB software 120 to run simulations is also depicted in FIG. 7. In addition, input data (not depicted) is adapted to be sent to the system bus 108 of the computer system either via an input device 138 or a storage medium 130 adapted to be connected to the system bus 108.

In operation, the processor 105 of the computer system 100 will execute the Hydro GeoBuilder (HGB) software 120 stored in the memory or program storage device 115 of the computer system 100 while, simultaneously, using the input data (from the input device 138 or stored in the storage medium 130 during that execution). When the processor 105 executes the Hydro GeoBuilder (HGB) software 120 stored in the memory or program storage device 115 (while using the input data), output data (not depicted) is sent to the display device 110, which will record or display visualizations such as that of objects, conceptual model objects or groundwater models. Output data may also be sent to the simulation software 121 to be used for running simulations. Output from the simulations may be used as input for the Hydro GeoBuilder (HGB) software 120.

The display device 110 may include a display screen of the computer system 100, and/or may include a printer to produce printouts generated by the computer system 100. The computer system 100 may be, for example, a personal computer. The memory or program storage device 115 may be a computer readable medium or a program storage device which is readable by a machine, such as the processor 105. The processor 105 may include, for example, a microprocessor, microcontroller, or a mainframe or workstation processor. The memory or program storage device 115 may be, for example, a hard disk, ROM, CD-ROM, DRAM, or other RAM, flash memory, magnetic storage, optical storage, registers, or other volatile and/or non-volatile memory.

Although the foregoing is provided for purposes of illustrating, explaining and describing certain embodiments of the invention in particular detail, modifications and adaptations to the described methods, systems and other embodiments will be apparent to those skilled in the art and may be made without departing from the scope or spirit of the invention.

What is claimed is:

1) A method of groundwater modeling comprising:
a) collecting, inputting, organizing and managing raw data concerning an aquifer in a data workspace;
b) developing a conceptual groundwater model, by creating a structural sub-model, a property sub-model and a boundary condition sub-model;
c) using the conceptual groundwater model to define a set of one or more simulation models;
d) converting the one or more simulation models into one or more numerical groundwater models having one or more grid types; and
e) running a simulation using one or more of the numerical models and analyzing the results.

2) The method of claim 1, further comprising feeding back results of the simulation into the data workspace.

3) The method of claim 1 wherein the raw data is imported into the data workspace from one or more data sources.

4) The method of claim 3 wherein the raw data is imported in the form of objects.

5) The method of claim 3 wherein the objects each have a geometry and at least one attribute attached to the geometry.

6) The method of claim 5 wherein the objects carry a revision history.

7) The method of claim 6 wherein the revision history for an object includes the creation date of the object, the author of the object, what other data were used for the object, and what operations were applied to the object.

8) The method of claim 4 wherein the collecting, inputting, organizing and managing raw data step (a) further comprises performing operations to derive new data types from the objects, the new data types serving as input for creating conceptual model objects.

9) The method of claim 1, further comprising using results of the simulation to identify steps to better manage the aquifer.

10) The method of claim 9 further comprising implementing one of the steps to better manage the aquifer.

11) An apparatus for modeling a groundwater aquifer comprising:
a) a data workspace having data in the form of one or more objects, each object having a geometry and at least one attribute attached to the geometry;
b) a coordinate system for use in editing the objects;
c) a conceptual model workspace having one or more conceptual model objects in one or more folders, the conceptual objects having been created from the data objects though one or more operations;
d) a conceptual model created from conceptual objects, having a structural sub-model, a property sub-model and a boundary condition sub-model;
e) an editor for editing objects in the data workspace to create the conceptual model objects for the conceptual data workspace;
f) a multi-dimensional viewer to view objects in the data workspace and to view conceptual model objects in the conceptual model workspace; and
g) a simulation model having one or more grid types, the simulation model created from the conceptual model by adding a simulation domain and one or more grid types.

12) A system for building a aquifer model comprising:
a) one or more sources of raw data concerning the aquifer;
b) a conceptual model builder having a data workspace for importing the raw data from the one or more sources of raw data, the raw data taking the form of one or more objects, each object having a geometry and at least one attribute attached to the geometry;
c) a coordinate system for use in editing the objects;
d) a conceptual model workspace having one or more conceptual model objects in one or more folders, the conceptual objects having been created from the data objects through one or more operations;
e) a conceptual model created from conceptual objects, having a structural sub-model, a property sub-model and a boundary condition sub-model;
f) an editor for editing objects in the data workspace to create the conceptual model objects for the conceptual data workspace;
g) a multi-dimensional viewer to view objects in the data workspace and to view conceptual model objects in the conceptual model workspace;
h) a simulation model having one or more grid types, the simulation model created from the conceptual model by adding a simulation domain and one or more grid types;
i) one or more numerical models translated from the simulation model; and
j) a simulator for running the numerical models.

13) A program storage device readable by a machine tangibly embodying a program of instructions executable by the machine to perform method steps for groundwater modeling, said method steps comprising:
a) inputting, organizing and managing collected raw data concerning an aquifer in a data workspace as objects;
b) creating conceptual model objects in a conceptual model workspace from the objects though one or more operations;
c) developing a conceptual groundwater model from the conceptual model objects, by creating a structural sub-model, a property sub-model and a boundary condition sub-model;
d) using the conceptual groundwater model to define a set of one or more simulation models;
e) converting the one or more simulation models into one or more numerical groundwater models having one or more grid types; and
f) running a simulation and analyzing the results.

14) The program storage device of claim 13, further comprising feeding back results of the simulation into the data workspace.

15) The program storage device of claim 13 wherein the raw data is imported into the data workspace from one or more data sources.

16) The program storage device of claim 13 wherein the objects each have a geometry and at least one attribute attached to the geometry.

17) The program storage device of claim 16 wherein the objects carry a revision history.

18) The program storage device of claim 17 wherein the revision history for an object includes the creation date of the object, the author of the object, what other data were used for the object, and what operations were applied to the object.

19) The program storage device of claim 13 wherein the inputting, organizing and managing collected raw data step (a) further comprises performing operations to derive new data types from the objects, the new data types serving as input for creating conceptual model objects.

20) The program storage device of claim 13, further comprising using results of the simulation to identify steps to better manage the aquifer.

21) The program storage device of claim 20 further comprising implementing one of the steps to better manage the aquifer.

22) The program storage device of claim 20 further comprising displaying objects on a multidimensional viewer.

23) A system for modeling groundwater comprising a processor, a data storage system, at least one input device, and at least one output device, a computer-readable media for storing data, the system comprising:
a) a data workspace for imported raw data collected from one or more sources of raw data, the raw data taking the form of one or more objects, each object having a geometry and at least one attribute attached to the geometry;
b) a coordinate system for use in editing the objects;
c) a conceptual model workspace having one or more conceptual model objects in one or more folders, the conceptual objects having been created from the data objects though one or more operations;
d) a conceptual model created from conceptual objects, having a structural sub-model, a property sub-model and a boundary condition sub-model;
e) an editor for editing objects in the data workspace to create the conceptual model objects for the conceptual data workspace;
f) a multi-dimensional viewer to view objects in the data workspace and to view conceptual model objects in the conceptual model workspace;
g) a simulation model having one or more grid types, the simulation model created from the conceptual model by adding a simulation domain and one or more grid types;
h) one or more numerical models translated from the simulation model; and
i) a simulator for running the numerical models.
